(19) United States
(12) Patent Application Publication
(10) Pub. No.: US 2017/0129517 A1
(43) Pub. Date: May 11, 2017

(54) BLOW MOLDED WASTE CART WITH MOLDED CIRCUMFERENTIAL COMPRESSION FLANGE

(71) Applicants: Bruce Hamilton, Jefferson, OH (US); Brian Moroney, Mentor, OH (US); Douglas Eck, Colwich, KS (US)

(72) Inventors: Bruce Hamilton, Jefferson, OH (US); Brian Moroney, Mentor, OH (US); Douglas Eck, Colwich, KS (US)

(73) Assignee: Toledo Molding & Die, Inc., Toledo, OH (US)

(21) Appl. No.: 15/172,437

(22) Filed: Jun. 3, 2016

Related U.S. Application Data
(60) Provisional application No. 62/170,542, filed on Jun. 3, 2015.

(51) Int. Cl. B62B 1/10; B29C 49/56; B65F 1/16; B65F 1/02; B65F 1/14; B29C 49/02; B29C 49/30

(52) U.S. Cl. CPC B62B 1/10; B29C 49/02; B29C 49/56; B29C 49/30; B65F 1/02; B65F 1/1452; B65F 1/1473; B65F 1/16; B62B 2202/20; B29L 2031/7126

(57) ABSTRACT

A body for a blow-molded waste cart and a waste cart having a blow-molded hollow body with four upstanding side walls and corner sections therebetween, a floor, and a circumferential compression flange around the side walls and corner sections is disclosed. The waste cart may also include an axle and wheels mounted to a side wall and a handle assembly with lid also mounted to a side wall. The circumferential compression flange may have a generally consistent width and thickness at each of the side walls and corner sections and the lid rim meets the circumferential compression flange when the lid is closed. A method of forming a blow-molded waste cart body is also disclosed. The process includes melting a polymer material to form a parison, enclosing the parison in a main mold, pressurizing the parison within the mold and moving a secondary mold section onto the main mold squeezing the polymer outward to a gap between the secondary mold and main mold to form the circumferential flange.

### TECHNICAL FIELD AND INDUSTRIAL APPLICABILITY OF THE INVENTION

The present invention relates to blow molded waste carts, also referred to as wheeled trashcans, which are substantially constructed of blow-molded polymeric materials. The present invention related specifically to a molded circumferential compression flange on the upper periphery of the cart body.

### BACKGROUND OF THE INVENTION

Blow molding is used to produce generally hollow plastic parts by melting plastic infeed material, forming a parison (a tubular piece of plastic), placing the parison into a mold and blowing air into the parison to force the plastic out to match the mold. The plastic cools and hardens within the mold and the mold is opened and the part is ejected. The main bodies of waste carts have been made by the blow molding process for many years.

### SUMMARY OF THE INVENTION

The present invention relates to blow-molded waste carts and more specifically to waste carts with a circumferential compression flange. Specifically, the waste cart includes body with four upstanding side walls and corner sections therebetween, a floor, and a circumferential compression flange around the side walls and corner sections is disclosed. The waste cart may also include an axle and wheels mounted to a side wall and a handle assembly with lid also mounted to a side wall. The circumferential compression flange has a generally consistent width and thickness at each of the side walls and corner sections and the lid rim meets the circumferential compression flange when the lid is closed. A method of forming a blow-molded waste cart body is also disclosed. The process includes melting a polymer material to form a parison, enclosing the parison in a main mold, pressurizing the parison within the mold and moving a secondary mold section onto the main mold squeezing the polymer outward to a gap between the secondary mold and main mold to form the circumferential flange.

### BRIEF DESCRIPTION OF THE DRAWING

A more complete appreciation of the invention and the many embodiments thereof will be readily obtained as the same becomes better understood by reference to the following detailed description when considered in connection with the accompanying drawings, wherein:

FIG. 1A illustrates a perspective view of a blow-molded waste cart having a circumferential compression flange in accordance with the present invention;

FIG. 1B illustrates a rear view of a blow-molded waste cart having a circumferential compression flange in accordance with the present invention;

FIG. 2 illustrates a top view of a blow-molded waste cart having a circumferential compression flange in accordance with the present invention;

FIG. 3A illustrates a detailed perspective view of a blow-molded waste cart having a circumferential compression flange in accordance with the present invention;

FIG. 3B illustrates a detailed top view of a blow-molded waste cart having a circumferential compression flange in accordance with the present invention;

FIG. 3B illustrates a detailed side view of a blow-molded waste cart having a circumferential compression flange in accordance with the present invention;

### DETAILED DESCRIPTION AND PREFERRED EMBODIMENTS OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

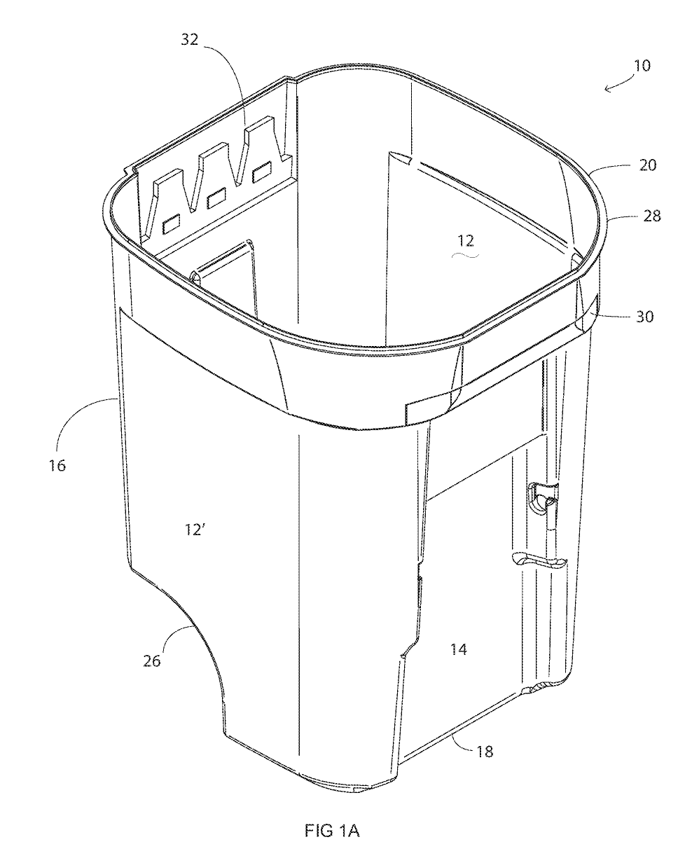

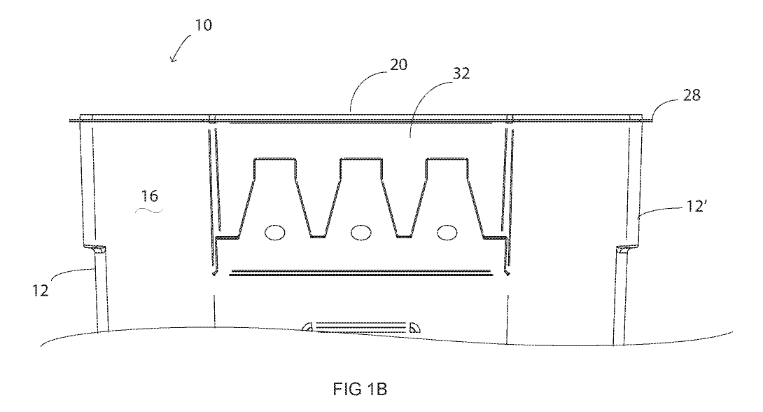

A blow-molded waste cart is shown in FIG. 1A. Cart 10 is formed of front wall 14, left and right walls 12, 12′ rare wall 16 having an upper rim 20 and floor 18 such that waste can be received. Body 10 includes a circumferential compression flange 28 formed below upper rim 20. Compression flange 28 reinforces the circumference of cart 10 and forms a seal to retain odors within the waste cart when a lid (not shown) is lowered. Compression flange 28 also inhibits pests from accessing the contents of cart 10. Cart 10 may also include a pocket lift 30, a wheel fender 26 and handle insert 32.

The blow molding process begins melting the polymer material and forming it into a parison. The parison is a polymer sleeve that is clamped into a mold. The mold includes two halves, which are generally referred to as the pin half and the bushing half. The pin half and bushing half are clamped around the parison. Air is then blown into the mold to force the parison against the mold to form the general shape of the cart. The mold includes a secondary (upper or lower) mold section that slides toward the pin half and bushing half. After the initial molding process, the secondary mold section moves to squeeze the polymer of the parison outward to a gap between the additional mold section and the pin half and bushing half. The polymer is forced out to form the circumferential flange. After the waste cart body is formed and the plastic has cooled somewhat, the secondary mold section is removed, the mold is opened and the waste cart is ejected.

The blow-molded cart 10 of the present invention, including a circumferential compression flange 28 is shown in FIG. 1B. Cart 10 includes rear wall 16, sidewalls 12, 12′ and front wall 14 (not shown) and an upper rim around the perfery thereof. The rear wall includes handle insert 32. The circumferential compression flange 10 forms a continuous reinforcement around the upstanding walls 12, 12′, 14, 16. The waste cart 10 is formed in a blow molding manufacturing process and compression flange 28 is formed in the mold during the blow molding process.

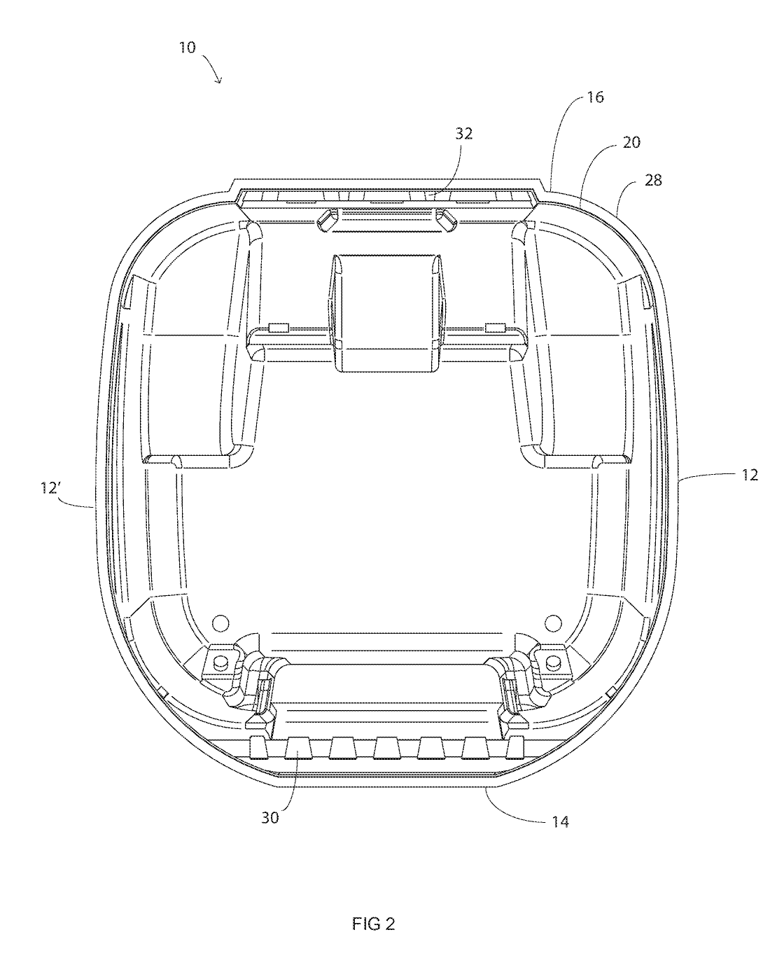

A top view of blow-molded cart 10 and circumferential compression flange 28 is shown in FIG. 2. Flange 28 is formed around upstanding walls 12, 12′, 14, 16 and optional arcuate corner sections. Handle insert 32 on rear wall 32 reinforced pocket lift 30 on front wall 14 are also shown. Compression flange 28 forms a continuous reinforcement around the upstanding walls and any arcuate sections.

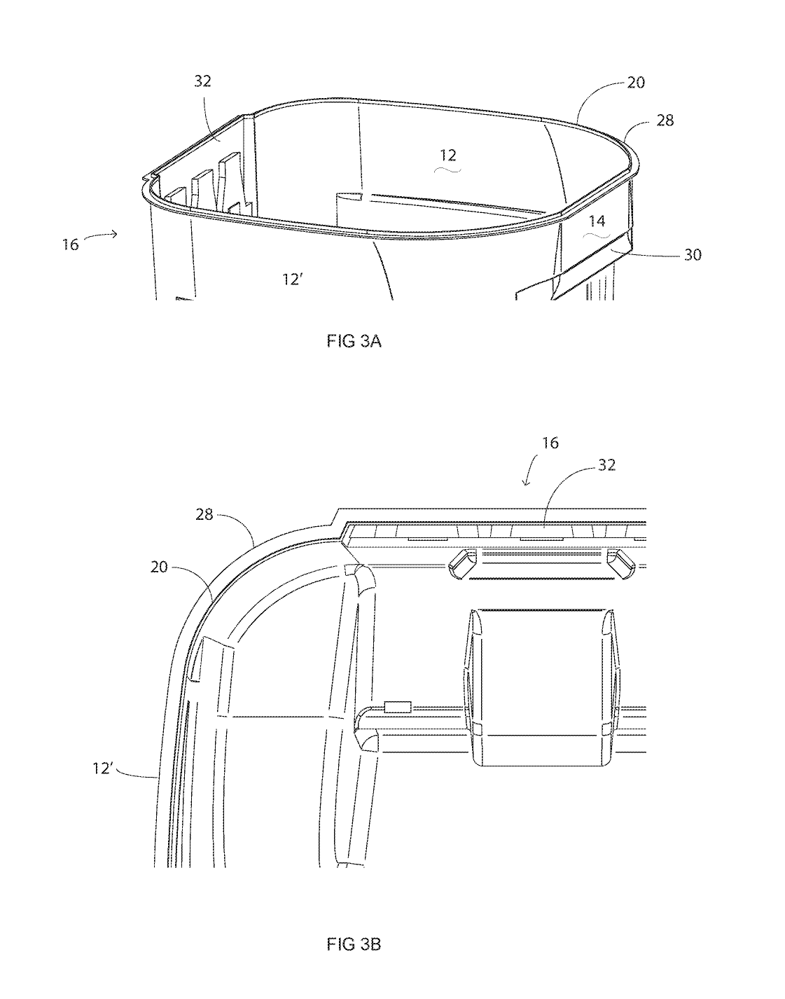

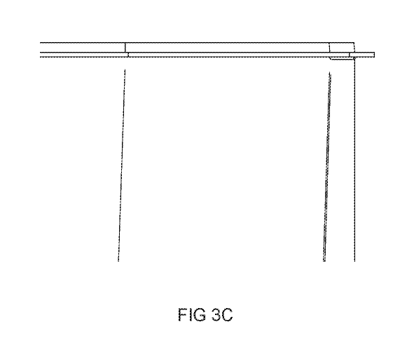

The blow-molded cart and circumferential compression flange is shown a detailed perspective view in FIG. 3A. Flange 28 is formed around upstanding walls 12, 12′, 14, 16 and optional arcuate corner sections. Handle insert 32 on rear wall 32 and reinforced pocket lift 30 on front wall 14 are also shown.

The top view of the blow-molded cart of the present invention is shown in greater detail in FIG. 3B. Flange 28 is shown on walls 12′, 16. Handle insert 32 on rear wall 32 reinforced pocket lift 30 on front wall 14 are also shown.

The top view of the blow-molded cart of the present invention is shown in greater detail in FIG. 3C with an upstanding wall and corner section being shown. The circumferential flange has a substantially consistent thickness at side wall and on the corner sections.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

We claim:

1. A blow-molded waste cart body, comprising:
a blow-molded hollow body having a four upstanding side walls and corner sections therebetween;
a floor, the body and floor forming a waste receptacle; and
a circumferential compression flange around the side walls and corner sections.

2. The blow-molded waste cart body of claim 1, wherein the circumferential compression flange has a consistent width at each of the side walls and corner sections.

3. The blow-molded waste cart body of claim 1, wherein the circumferential compression flange has a consistent thickness at each of the side walls and corner sections.

4. A blow-molded waste cart, comprising:
a blow-molded hollow body having a four upstanding side walls and corner sections therebetween;
a floor, the body and floor forming a waste receptacle;
an axle and wheels mounted to a side wall;
a handle assembly with lid mounted to a side wall; and
a circumferential compression flange around the side walls and corner sections.

5. The blow-molded waste cart of claim 4, wherein the circumferential compression flange has a consistent width at each of the side walls and corner sections.

6. The blow-molded waste cart of claim 4, wherein the circumferential compression flange has a consistent thickness at each of the side walls and corner sections.

7. The blow-molded waste cart of claim 4, wherein the lid has a rim and the lid rim meets the circumferential compression flange when the lid is closed on the waste cart.

8. A method of forming a blow-molded waste cart body comprising the steps of:
melting a polymer material;
forming the polymer material into a parison;
enclosing the parison in a main mold having a pin half and a bushing half;
pressurizing the parison within the mold; and
moving a secondary mold section onto the main mold squeezing the polymer outward to a gap between the secondary mold and main mold forming a circumferential flange.

9. The method of claim 8 further comprising the steps of:
cooling the polymer;
removing the secondary mold section;
opening the main mold and
ejecting the waste cart body.
